(19) United States
(12) Patent Application Publication
(10) Pub. No.: US 2010/0125891 A1
(43) Pub. Date: May 20, 2010

(54) Activity Monitoring And Information Protection

(76) Inventor: Prakash Baskaran, Bangalore (IN)

Correspondence Address: Ashok Tankha, 36 Greenleigh Drive, Sewell, NJ, 08080, US

(21) Appl. No.: 12/352,604

(22) Filed: Jan. 12, 2009

(30) Foreign Application Priority Data
Nov. 17, 2008 (IN) 2826 /CHE/2008

(51) Int. Cl. G06F 21/00; H04L 9/00

(52) U.S. Cl. 726/1; 713/165; 726/4

(57) ABSTRACT

Disclosed herein is a computer implemented method and system for monitoring user activity and protecting information in an online environment. A security client application is provided on a computing device of a user. A local software component preloaded on the computing device is embedded within the security client application on the computing device. The security client application queries a policy server for a security policy for the user on receiving a request for access to the information from the user. The user is granted controlled access to the information based on the security policy. The granted controlled access enables enforcement of the security policy. The security client application permits the user to perform predefined activities on the information using the granted controlled access. The security client application prevents the user from performing activities apart from the predefined activities. The security client application tracks the performed predefined activities.

### CROSS REFERENCE TO RELATED APPLICATIONS

This application claims the benefit of non-provisional patent application number “2826/CHE/2008” titled “Activity Monitoring And Information Protection”, filed on Nov. 17, 2008 in the Indian Patent Office.

### BACKGROUND

This invention, in general, relates to information protection. More particularly, this invention relates to monitoring user activities, enforcing information technology (IT) policies and protecting information in an online environment.

Information security is a major concern in most corporate organizations. Corporate organizations often store sensitive information in computer systems and databases. The sensitive information may be business secrets, client details, employee details, etc. Leakage of the sensitive information has the potential of disadvantaging or harming corporate organizations. Apart from facing unfair competition resulting from the leakage, corporate organizations may fail to comply with government regulations and may also be found in violation of confidentiality agreements, potentially leading to lawsuits against the corporate organizations.

Modern technology permits easy transfer of data via universal serial bus (USB) drives, writeable compact disks, and wireless protocols such as infrared and Bluetooth™. People typically possess at least one device capable of removable storage in the form of mobile phones, portable music players, digital cameras, etc. Employees of a corporate organization may copy the sensitive information onto the removable storage devices, thereby creating a risk of loss of such corporate data. Scanning or frisking each employee to check for the removable storage devices is a time consuming, tedious, and impracticable solution.

Furthermore, uncontrolled and easy access of corporate data over the internet also enables the employees to place the information security at risk. The employees may access the information via the web or a virtual private network from computers at home, hotels, internet cafes, or other public computers. When the information is accessed from an external computer outside the corporate environment, the corporate organizations have little or no control over the information displayed or downloaded onto the computer. The sensitive information may then be transferred to a memory device or emailed to external addresses. Generally corporate organizations have no control over such activities or the ability to determine possible usage violations. In general, organizations stand to lose in many ways if the downloaded information is accessed by competing firms or is in violation of regulatory or compliance requirements.

In addition to information security concerns, internet access also enables employees to spend time on non-work related websites during work hours within the corporate network, thereby decreasing the productivity of the employees.

Different computer and network usage policies may be implemented in corporate organizations to prevent information leakage. However, the usage policies may be easily bypassed or overlooked by a user using the computer network. Furthermore, usage policies typically implement blanket access control strategies and cannot be readily modified for each user. Furthermore, corporate organizations generally cannot track user activities that could potentially lead to a data leak and also cannot identify details of activities performed by the user on the computing resources of corporate organizations. In addition to corporate organizations, there is also a need for information protection in other fields, for example, in government offices, banking firms, private companies, security agencies, etc.

Hence, there is an unmet need for monitoring user activity and protecting information in an online environment.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for monitoring user activity, enforcing information technology (IT) policies and protecting information in an online environment. A security client application is provided on a computing device of a user. A local software component is embedded within the security client application on the computing device. The local software component is preloaded on the computing device. The local software component may be any software component that accesses information via a network. As used herein, the term “software component” refers to a system element offering a predefined service or event, and able to communicate with other components. The local software component may be a stand-alone software application, or a software element typically running in context of another software application. The local software component may also be preconfigured to connect with specific remote corporate computers. The user provides login credentials to the security client application for authentication by the policy server. Alternatively, the policy server may contact a remote corporate server for the authentication. The security client application queries a policy server for a security policy for the user on receiving a request for access to the information from the user.

The user is granted controlled access to the information based on the security policy. The granted controlled access enables enforcement of the security policy. The user is allowed the granted controlled access to the information using the embedded local software component via the security client application. The user is disallowed from accessing the information using the local software component independent of the security client application.

The security client application permits the user to perform only predefined activities on the information using the granted controlled access. The security client application prevents the user from performing activities apart from the predefined activities. The security client application also permits the user to perform only predefined activities on the computing device of the user based on the security policy. The security client application also prevents the user from performing activities apart from the predefined activities on the computing device. The security client application may generate an alert on detection of an attempt to violate the security policy.

The security client application tracks the performed predefined activities on the information. The security client application transfers a record of the tracked activities to the policy server for future use. The security client application may also track the activities performed by the user on the user's computing device while accessing the information. The security client application may scan the information for detecting sensitive information. The security client application may encrypt a file containing the sensitive information on detecting transfer and storage activities performed by the user on the file containing the sensitive information.

The local software component may be terminated on termination of the security client application. The termination may comprise removal of temporary files created by the local software component on the computing device of the user.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of monitoring user activity and protecting information in an online environment.

FIG. 2 illustrates a computer implemented system for monitoring user activity and protecting information in an online environment.

FIGS. 3A-3B exemplarily illustrate a flowchart of the steps involved in allowing connections to a remote server via a security client application.

FIG. 4 exemplarily illustrates establishment of a connection from a computing device to a corporate web server in a corporate environment via the security client application with a web browser as the embedded local software component.

FIG. 5 exemplarily illustrates establishment of a virtual private network connection from a computing device to a corporate resource in a corporate environment via the security client application with a virtual private network client as the embedded local software component.

FIGS. 6A-6G exemplarily illustrate screenshots of options for modifying the security policy for a user or a group of users.

### DETAILED DESCRIPTION OF THE INVENTION

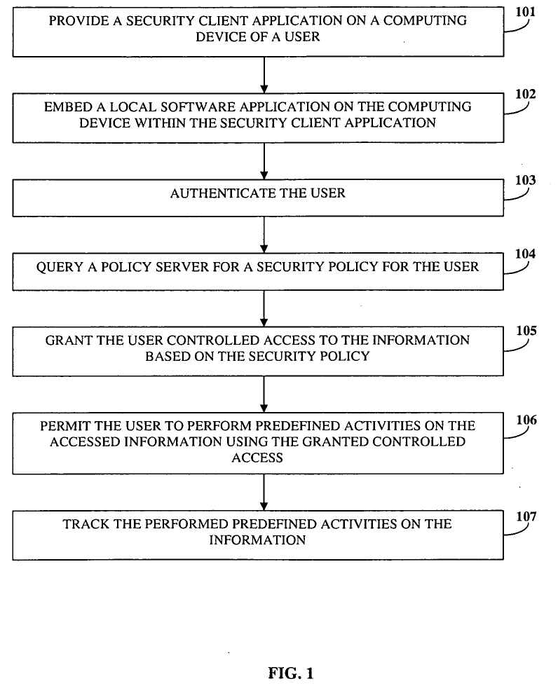

FIG. 1 illustrates a computer implemented method of monitoring user activity and protecting information in an online environment. The online environment may, for example, be the internet or a corporate intranet. The information may be stored in one or more online resources, for example, a corporate database, a remote computer, or a web server. A security client application is provided 101 on a computing device of a user. The user's computing device may, for example, be a personal computer, a laptop, a personal digital assistant, a mobile device enabled with internet capabilities, etc.

A local software component is embedded 102 within the security client application on the computing device. As used herein the term “software component” refers to a system element offering a predefined service or event, and able to communicate with other components. The local software component may, for example, be a web browser, a virtual private network (VPN) client, an electronic mail (email) client, a database administrator tool, a database client application, etc., or any software component that accesses information via a network, for example, the internet or an intranet, or on a desktop computer, and functions in a client server model. The local software component may be a stand-alone software application or a software element typically running in context of another software application, for example, an ActiveX™ control, a Java™ applet, a Flash™ object, etc.

The local software component is preloaded on the computing device. The local software component may be preconfigured to connect to specific online resources, for example, remote corporate computers. The security client application forms a software wrapper around the local software component. Inbound and outbound communications of the local software component are monitored by the security client application. The security client application is able to embed more than one local software component as well as more than one instance of a single local software component.

When a user requests for access to the information in the online environment, a policy server authenticates 103 the user. The user provides login credentials, for example, a combination of a username and a password, a digital signature, a personal security certificate, etc. for authentication by the policy server. The user may be authenticated at a policy server. The policy server may further contact an external authentication server, for example, an active directory (AD) or a lightweight directory access protocol (LDAP) server for the authentication. After successful authentication, the security client application queries 104 the policy server for a security policy for the authenticated user. The step of authentication may be bypassed if a single security policy applies for multiple users accessing the information.

The security policy may comprise a predefined list of online resources accessible by the user and a predefined list of actions the user may perform on the information and on the computing device while accessing the information. In a multiple user environment, each of the users' security policy may be based on a user group that the user belongs to as configured in the policy server. For example, in a corporate environment, the security policy for each of the users may be determined by the policy server based on position of the user in the corporate environment, job profile of the user, etc.

The user is granted 105 controlled access to the information based on the security policy. The granted controlled access enables enforcement of the security policy. The user is allowed the granted controlled access to the information using the embedded local software component via the security client application. In one implementation, the user may only be allowed to access the information permitted to the user by the security policy. For example, a software developer at a software company may be allowed to access a list of old projects for reference, but an accountant at the same software company may not be allowed to access the list. However, the accountant may be allowed to view financial records of the software company, whereas the software developer may not. At the same time, a project manager may be allowed to access both the list of old projects and the financial records of the software company.

The local software component communicates with the online resources via the security client application. The user is disallowed from accessing the information using the local software component independent of the security client application. The online resources may be configured to communicate only via the security client application. In case of multiple online resources, a proxy server may be used to ensure that the online resources communicate only via the security client application. The proxy server denies connections from other applications other than the security client application. The online resources or proxy servers may identify the security client applications by a digital signature of the security client application. The online resources deny the local software component access to the online resources when the local software component is used independent of the security client application. If the proxy server is used, the online resources may be placed behind a firewall, thereby eliminating direct exposure of the online resources to a network, for example, the internet. Furthermore, the proxy server is configured to accept connections only from the security client application. The online resources do not have to be modified in any way to ensure that the connections are coming only from the secure client application.

The security client application permits 106 the user to perform predefined activities on the accessed information using the granted controlled access. Permitting the user to perform the predefined activities comprises preventing the user from performing activities apart from the predefined activities. The user may be permitted to access part of the information or some of the online resources. The security policy may provide a list of blocked websites the user is not permitted to access, and the user is prevented from accessing the blocked websites. The user may also be permitted to save parts of the information, print parts of the information, take a screenshot of the information, etc, based on the security policy. Forwarding email containing sensitive information to an unauthorized user may be permitted or prevented based on the security policy for the user. Email attachments may be allowed or disallowed based on the security policy of the user. If email attachments are allowed, the email attachments may be scanned and encrypted before sending or receiving. Downloading files from the internet or from a remote computer may also optionally be prevented.

The security client application permits the user to perform predefined activities on the computing device of the user. Permitting the user to perform the predefined activities on the computing device comprises preventing the user from performing activities apart from the predefined activities on the computing device. Encryption may be enforced for any data transferred on the removable storage media. The user may be disallowed from printing or electronically transmitting sensitive information. A predefined set of software applications on the local computing device may be blocked. For example, games, image editing software applications, and multimedia content players may be blocked. The software applications may be blocked based, for example, on an application name, a window caption, a manufacturer name, or a location of an executable file of the software applications. Installing and uninstalling software applications on the computing device may also be prevented. Storing data on removable storage media may be disallowed. Installation of new hardware components may be disallowed.

The predefined activities performed by the user on the information are tracked 107 using the security client application. The activities tracked may, for example, display the accessed information, modifying the accessed information, copy whole or part of the accessed information, etc. The activities are monitored and recorded for future reference with detailed forensic information. Tracking the activities may further comprise capturing and recorded user inputs, for example, mouse clicks and keyboard inputs. Screenshots of a display screen of the user may be captured at regular intervals of time or upon the user performing a particular type of activity. Further, a list of web pages accessed by the user may be tracked and recorded. Inbound and outbound email communication of the user may also be tracked and recorded along with the additionally optional details of the email communication, for example, information on the recipients of the email, attachment details, content of the email, etc.

The information accessed by the user may further be scanned for detection of sensitive information, for example, credit card numbers, social security numbers, bank account details, etc. Sensitive information may be defined at the policy server as patterns that identify confidential information. The security client application may scan for sensitive information during access of the information on the computing device. For example, if a file is attached to an email, the security client application may scan the attachment for a text pattern that matches a credit card number. Alternatively, the security client application may scan text typed into an instant messenger application to match with predefined patterns. If the security client application finds any sensitive information, the activities may be monitored and logged or such transactions can be blocked immediately to prevent data leaks.

An administrator may also be alerted via email or text message through a mobile phone on detecting the sensitive information. Furthermore, the activities performed by the user wherein the sensitive information is detected may be blocked. For example, on detecting sensitive information on the display screen of the user, an alert may be sent to the administrator. If the user is found typing or copying sensitive information into an application, the activities involving the typing and copying may be blocked. The sensitive information in files transferred by the user through applications may further be encrypted for additional security to avoid accidental data leaks. With instructions obtained from the security policy, the security client application may encrypt the files containing sensitive information during transfer and storage activities performed by the user, for example, while uploading files to a website, attaching files to an email, copying files to a universal serial bus (USB) drive, etc. in order to avoid accidental data leaks. The encrypted files may be password protected, so that only an authorized user with the password can reopen the encrypted files in the future.

Activities performed by the user on the computing device of the user may also be tracked. The activities performed on the computing device may, for example, comprise modifying a locally or remotely stored file, copying the stored file, etc. Removable storage media, for example, optical drives and universal serial bus (USB) drives, may be scanned. Data transferred to and from the removable storage media may be monitored and recorded. Communication over communication ports, for example, serial communication ports, parallel communication ports, institute of electrical and electronics engineers (IEEE) 1394 ports, local area network drives, etc, of the computing device may also be monitored and recorded. Content printed or electronically transmitted, for example, by facsimile (fax), by the user may also be tracked and may be scanned for sensitive information. A list of software applications launched and used by the user may be tracked and recorded, along with order of access and time period of each access. A screenshot of each software application may be taken and stored when the software application is launched.

The security client application transfers a record of the tracked activities to the policy server at predefined intervals of time for future use. As used herein, the term “record” refers to a chronological log of tracked information created by the security client application on the computing device. The record may, for example, comprise forensic information, associated screenshots, logs of tracked activities, and other user data that may be utilized by an administrator of the policy server during review and report generation. The predefined intervals of time may be defined in the security policy. The record may, for example, be used for determining violations of the security policy by the user, maintaining a record of corporate resource usage, monitoring productivity of the user, etc. Violations of the security policy may comprise attempts to access blocked websites, launching blocked applications, printing or electronically transmitting sensitive information, saving sensitive data on removable storage media, forwarding a sensitive email to an unauthorized recipient, etc. The record may also be used by an administrator of the policy server to modify the security policy based on usage. For example, if an unblocked non-work related website is frequently accessed by the user, the administrator may modify the security policy for the user, blocking the non-work related website. Further, the record provides the administrator with detailed information on computer and network usage. An alert may also be generated on detection of an attempt to violate the security policy. The generated alert may be provided to the administrator via email or via a text message to a mobile device of the administrator.

The local software component may be terminated on termination of the security client application. The termination may comprise removal of temporary files created by the local software component on the computing device of the user. Temporary files created by the security client application may also be removed. The temporary files are removed to prevent future back-door access to the accessed information independent of the security client application.

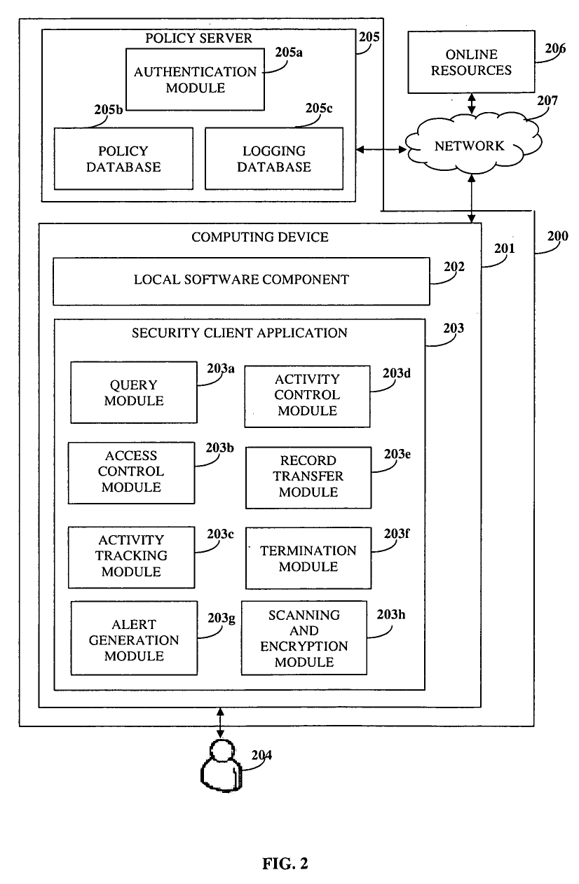

FIG. 2 illustrates a computer implemented system 200 for monitoring user activity and protecting information in an online environment. The system 200 disclosed herein comprises a local software component 202 embedded within a security client application 203 on a computing device 201, and a policy server 205. The security client application 203 comprises a query module 203a, an access control module 203b, an activity tracking module 203c, an activity control module 203d, a record transfer module 203e, a termination module 203f, and an alert generation module 203g, and a scanning and encryption module 203h.

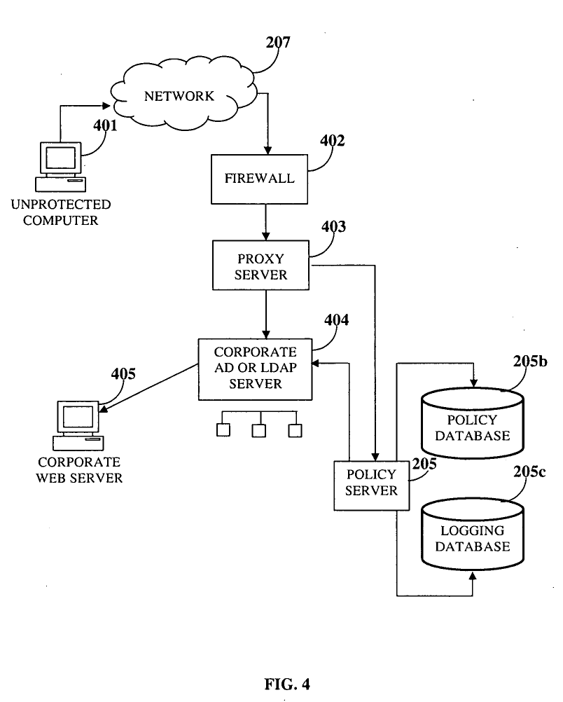

The policy server 205 may comprise an authentication module 205a or may be connected to an external active directory (AD) server or an external lightweight directory access protocol (LDAP) server 404, as exemplarily illustrated in FIG. 4. The policy server 205 further comprises a policy database 205b and a logging database 205c. The computing device 201 communicates with the policy server 205 and multiple online resources 206 via a network 207. The network 207 may, for example, be the internet or a corporate intranet.

The security client application 203 is provided on the user's 204 computing device 201. The user 204 requests for access to the information from the online resources 206. The user 204 provides login credentials. The authentication module 205a of the policy server 205 authenticates the user 204. The policy server 205 may also contact the external AD server or LDAP server 404 for the authentication. The query module 203a queries the policy server 205 for a security policy for the user 204. The policy server 205 provides the security policy for the user 204 to the security client application 203. The policy server 205 may retrieve the security policy from the policy database 205b. The access control module 203b grants the user 204 to controlled access to the information from the online resources 206 using the embedded local software component 202 via the security client application 203 based on the security policy. The granted controlled access enables enforcement of the security policy. The access control module 203b allows the user 204 the granted controlled access to the information using the embedded local software component 202. The access control module 203b disallows the user 204 to access the information using the local software component 202 independent of the security client application 203.

The scanning and encryption module 203h scans the accessed information for detecting sensitive information. The scanning and encryption module 203h encrypts files containing sensitive information on detecting transfer and storage activities performed by the user 204 on the file containing the sensitive information. Encryption is performed to prevent unauthorized access to the file being transferred outside the computing device 201, thereby providing additional security.

The activity control module 203d permits the user 204 to perform predefined activities on the information using the granted controlled access. The activity control module 203d prevents the user 204 from performing activities apart from the predefined activities. The predefined activities prevented may comprise accessing part of the information, accessing a predefined list of websites, saving the information, taking screenshots of the information, sending email to a predefined list of recipients, etc. The activity control module 203d also prevents the user 204 from performing predefined activities on the computing device 201 of the user 204. For example, the activity control module 203d may prevent the user 204 from printing information, storing the information on removable storage media, launching a predefined set of software applications or a set of windows, etc. The activity control module 203d prevents the user 204 from performing activities apart from the predefined activities on the computing device 201.

The activity tracking module 203c tracks the predefined activities performed by the user 204 on the information. The activities tracked may comprise displaying the accessed information, modifying the accessed information, copying whole or part of the accessed information, etc. The activity tracking module 203c also tracks activities performed by the user 204 on the user's 204 computing device 201. The activities tracked on the computing device 201 may comprise modifying a locally or remotely stored file, copying the stored file, etc. The activity tracking module 203c may also monitor and record activities involving removable storage media, network connections, and printing and electronically transmitting the accessed information.

The record transfer module 203e transfers a record of the tracked activities at predefined intervals of time to the policy server 205 for future use, for example, for determination of violations of the security policy by the user 204. The record may also be used by an administrator of the policy server 205 to modify the security policy based on usage. The logging database 205c of the policy server 205 stores the transferred record of the user activities. The alert generation module 203g generates an alert on detecting an attempt to violate the security policy. The generated alert may be provided to the administrator. The termination module 203f terminates the local software component 202 on termination of the security application 203. The termination module 203f further removes or deletes temporary files created by the local software component 202 on the computing device 201 of the user 204. The termination module 203f removes the temporary files to prevent future back-door access to the accessed information independent of the security client application 203.

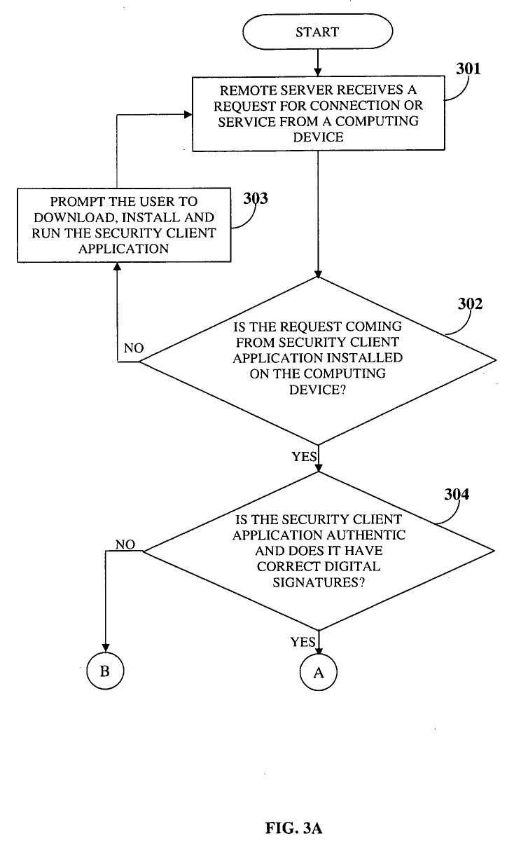

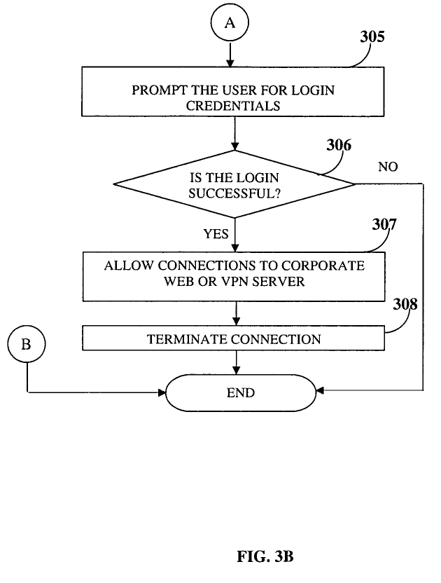

FIGS. 3A-3B exemplarily illustrate a flowchart of the steps involved in allowing a connection to a remote server via the security client application 203. The remote server may be a corporate web server or a virtual private network (VPN) server. The remote server receives 301 a request for a connection or a service from a computing device 201. The remote server checks 302 if the request is coming via the security client application 203. If the request is not coming via the security client application 203, the user 204 of the computing device 201 is prompted 303 to download, install, and run the security client application 203. The security client application 203 may be downloaded by the user 204 from the corporate web server. After installing the security client application 203, the computing device 201 may again make a request for a connection or service.

If the request for a connection is coming from the security client application 203, the remote server checks 304 if the security client application 203 is authentic and has correct digital signatures. If the security client application 203 is not authentic or has incorrect digital signatures, the connection is terminated 308 and the request for the connection is denied. If the security client application 203 is authentic and has the correct digital signatures, the user 204 is prompted 305 for login credentials for access to the remote server. The remote server checks 306 if the login is successful. If the login is unsuccessful, the connection is terminated 308. If the login is successful, the connection from the computing device 201 to the remote server is allowed 307. The connection may be terminated at the discretion of the user 204 at a later point in time.

FIG. 4 exemplarily illustrates establishment of a connection from a computing device 201 to a corporate web server 405 in a corporate environment via the security client application 203 with a web browser as the embedded local software component 202. The computing device 201 may be an unprotected computer 401 outside the corporate environment running the security client application 203. The security client application 203 requests for a connection to a corporate web page hosted on the corporate web server 405 via a network 207. The network 207 may, for example, be the internet. The request is routed via a firewall 402 to a proxy server 403. The proxy server 403 ensures that the connection request is coming from the security client application 203 by verifying a header in the received connection request. If the connection request comes from any application other than the security client application 203, the proxy server 403 denies the connection. The proxy server 403 prompts the user 204 for login credentials to view the corporate web page. The login credentials may be validated at the policy server 205, at a corporate lightweight directory access protocol (LDAP) server or at an active directory (AD) server 404.

The policy server 205 sends the security policy for the user 204 to the security client application 203. The security policy for the user 204 may be retrieved from a policy database 205b. The security client application 203 receives the security policy and enforces the security policy. The security client application 203 then sends a confirmation to the proxy server 403 to initiate the connection with the corporate web server 405. The proxy server 403 initiates the connection. Activities performed by the user 204 on the computing device 201 are tracked and recorded. A record of the activities performed by the user 204 may be sent to the policy server 205. The record may be stored in a logging database 205c.

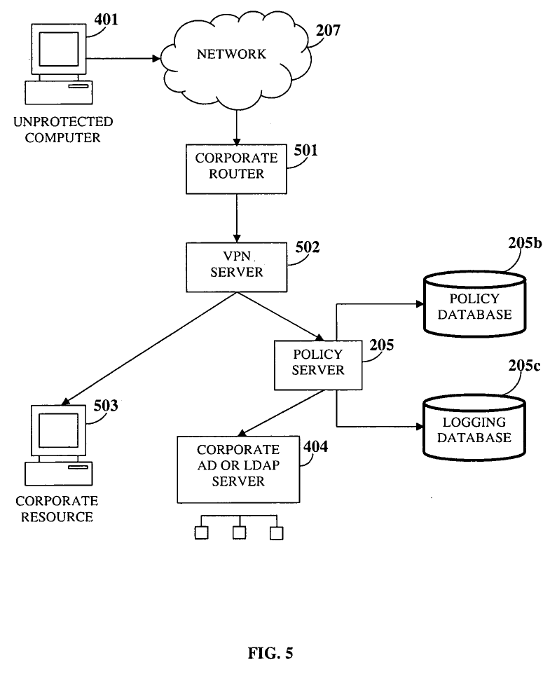

FIG. 5 exemplarily illustrates establishment of a virtual private network (VPN) connection from a computing device 201 to a corporate resource 503 in a corporate environment via the security client application 203 with a VPN client as the embedded local software component 202. The computing device 201 may be an unprotected computer 401 outside the corporate environment running the security client application 203 with an embedded VPN client. The security client application 203 requests for a VPN connection over the network 207. The network 207 may, for example, be the internet. The request is routed via a corporate router 501 to a VPN server 502. The VPN server 502 ensures that the connection request is coming from the security client application 203 by verifying a header in the received connection request. If the connection request comes from a VPN client used independent of the security client application 203, the VPN server 502 denies the connection. The VPN server 502 prompts the user 204 for login credentials to view the corporate web page. The login credentials may be validated at the policy server 205, at a corporate LDAP server or at an AD server 404.

The policy server 205 sends the security policy for the user 204 to the security client application 203. The security policy for the user 204 may be retrieved from a policy database 205b. The security client application 203 receives the security policy and enforces the security policy. The security client application 203 then sends a confirmation to the VPN server 502 to initiate the connection with the corporate resource 503. The corporate resource 503 may be a web server, a file server, an application server, a database server, or a combination thereof. The corporate resource 503 may host any application or information that may be accessed via a VPN connection. The VPN server 502 initiates the connection. Activities performed by the user 204 on the computing device 201 are tracked and recorded. A record of the activities performed by the user 204 may be sent to the policy server 205. The record may be stored in a logging database 205c.

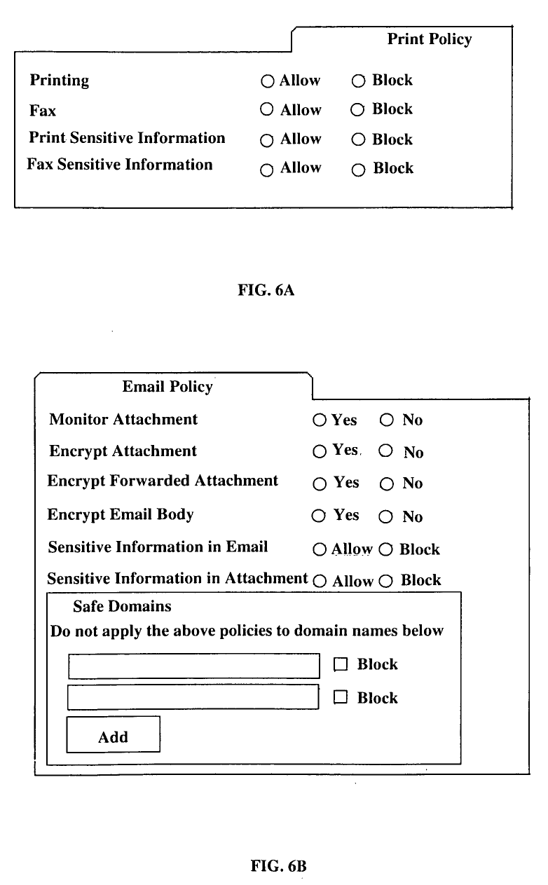

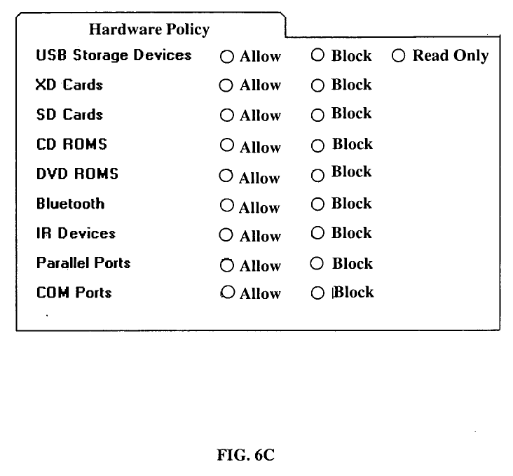

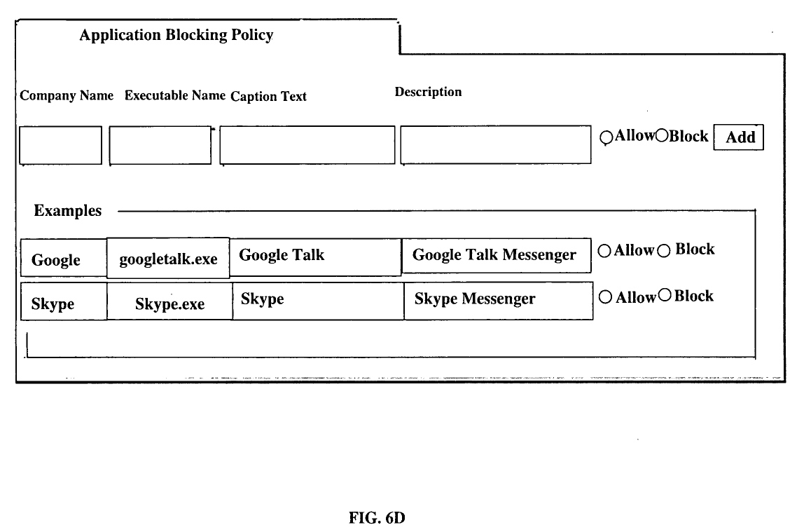

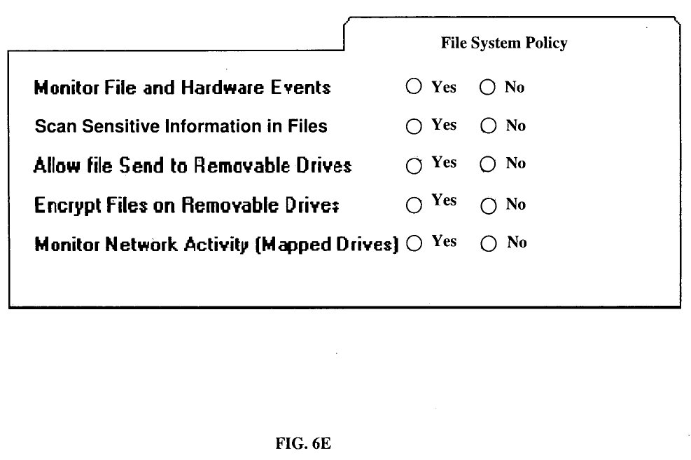

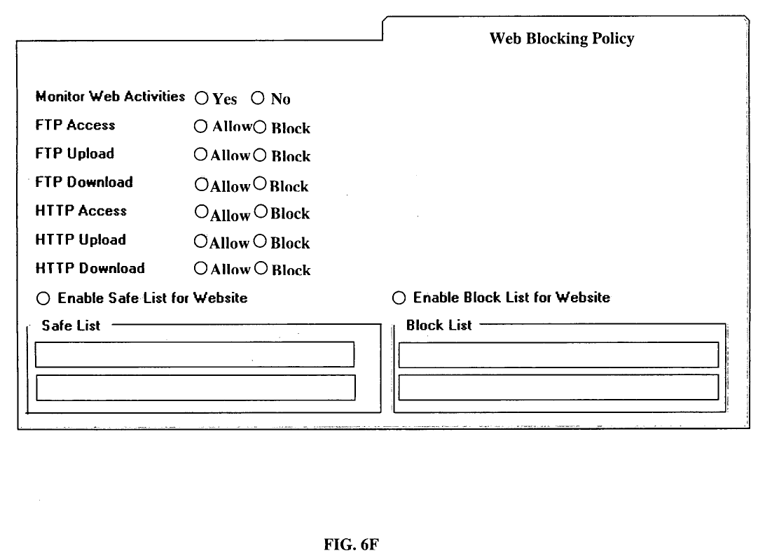

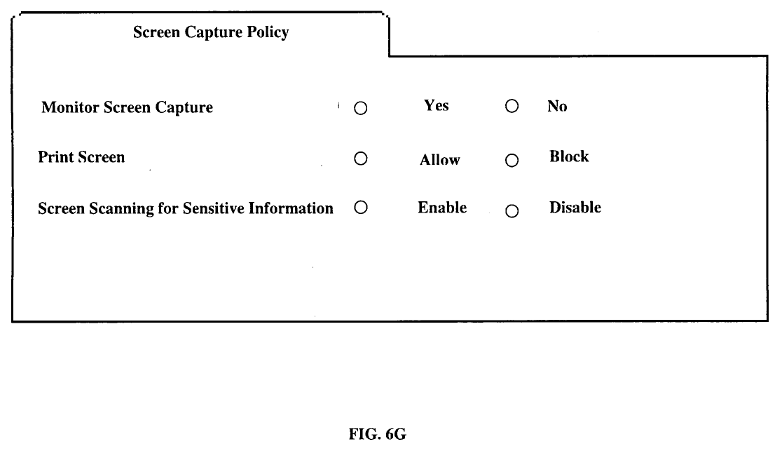

FIGS. 6A-6G exemplarily illustrate screenshots of options for modifying the security policy for the user 204 or a group of users. The security policy may be modified by an administrator of the policy server 205. FIG. 6A exemplarily illustrates modification of a print policy for the user 204. The print policy may be modified to allow or disallow the user 204 to print or fax the accessed information. The print policy may further be modified to allow or disallow the user 204 to print or fax sensitive information from the accessed information. FIG. 6B exemplarily illustrates modification of an email policy. The email policy may be modified to monitor email attachments, to enforce attachment encryption, to enforce email encryption, and to define a list of “safe” domains to which emails may be sent by the user 204. The email policy may further be modified by the user 204 to allow or disallow sensitive information to be sent or received via email. FIG. 6C exemplarily illustrates modification of a hardware policy for the user 204. The hardware policy may be modified to allow or disallow usage of removable storage media and wireless communication via infrared (IR) or Bluetooth™ protocols. The removable storage media may, for example, be universal serial bus (USB) devices, xD picture card™, secure digital (SD) cards, compact disc (CD), digital versatile disc (DVD), etc. The hardware policy may allow definition of a list of “safe” removable storage media which are allowed to be used on the computing device 201.

FIG. 6D exemplarily illustrates modification of an application blocking policy for the user 204 or a group of users. The application blocking policy may be used to block usage of specific software applications on the computing device 201. The software applications may be blocked based on company name of the software application, executable file name of the software application, caption text of the software application, or based on the description of the software application. In FIG. 6D, the application blocking policy is used to block an instant messaging client.

FIG. 6E exemplarily illustrates modification of a file system policy for the user 204 or a group of users. The file system policy enables defining of rules for files stored on the computing device 201. The file system policy enables monitoring of file and hardware events. The file system policy enables scanning of sensitive information in the files. The file system policy may allow or disallow transferring files to and from a removable storage media. The files may be prevented from being stored on the removable storage media. Further, the file system policy enables encryption of files stored on removable storage media. The file system policy may enable defining of a maximum file threshold value, whereby the user 204, for example, is disallowed from accessing or copying a number of files more than the threshold value. The file system policy may enable monitoring of network activities, for example, on mapped network drives of the user 204 and prevents predefined activities in a corporate environment to ensure efficient usage of the computing resources.

FIG. 6F exemplarily illustrates modification of a web blocking policy for the user 204 or a user group. The web blocking policy may enable monitoring of web activities of the user 204 or the user group. The web blocking policy may allow or disallow network protocol activities based on rules defined by the administrator. The network protocol activities may, for example, be hyper text transfer protocol (HTTP) access, HTTP upload, HTTP download, file transfer protocol (FTP) access, FTP upload, FTP download, etc. Further, the web blocking policy may enable the administrator to define a list of websites that the user 204 may be allowed or disallowed from accessing.

FIG. 6G exemplarily illustrates modification of a screen capture policy for the user 204 or a user group. The screen capture policy may enable monitoring of screen capture. Furthermore, the screen capture policy may allow or disallow different screen capturing functions, for example, print screen. The screen capture policy may further enable or disable scanning display of the computing device 201 for sensitive information while performing the screen capture.

Tracking of user activities and the prevention of the predefined activities may be implemented in a corporate environment to ensure efficient usage of the computing resources. The record transmitted to the policy server 205 ensures that any attempt made by the user 204 to bypass the tracking and prevention is recorded for future review. Furthermore, the modification of the security policy ensures that the security policy may easily be modified by an administrator. The security policy may be modified to suit changing needs of the corporate environment, or to adapt for changes in the job profile or access requirements of the user 204, or to adapt to corporate governance or compliance requirements. The policy server 205 may apply a single security policy for multiple users by grouping the users into user groups.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the policy database 205b and the logging database 205c, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

The foregoing examples have been provided merely for the purpose of explanation and are in no way to be construed as limiting of the present invention. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented method of monitoring user activity and protecting information in an online environment, comprising the steps of:
providing a security client application on a computing device of a user;
embedding a local software component within said security client application, wherein said local software component is preloaded on said computing device;
querying a policy server for a security policy for said user by the security client application on receiving a request for access to said information from the user;
granting the user controlled access to the information based on said security policy, wherein said granted controlled access enables enforcement of the security policy, wherein the user is allowed the granted controlled access to the information using said embedded local software component via the security client application;
permitting the user to perform predefined activities on the information using the granted controlled access, wherein said step of permitting the user to perform said predefined activities comprises preventing the user from performing activities apart from said predefined activities; and
tracking said performed predefined activities on the information using the security client application;
whereby said user activity is monitored and the information in said online environment is protected.

2. The computer implemented method of claim 1, further comprising the step of transferring a record of said tracked activities to said policy server by the security client application for future use.

3. The computer implemented method of claim 1, further comprising the step of disallowing the user to access the information using the local software component independent of the security client application.

4. The computer implemented method of claim 1, further comprising the step of generating an alert on detection of an attempt to violate the security policy by the security client application.

5. The computer implemented method of claim 1, further comprising the step of authenticating the user by said policy server on receiving said request for said access to the information from the user.

6. The computer implemented method of claim 1, further comprising the step of tracking activities performed by the user on the computing device of the user by the security client application.

7. The computer implemented method of claim 1, further comprising the step of permitting the user to perform predefined activities on the computing device of the user based on the security policy, wherein said step of permitting the user to perform said predefined activities on the computing device comprises preventing the user from performing activities apart from the predefined activities on the computing device.

8. The computer implemented method of claim 1, further comprising the step of scanning the information for detecting sensitive information by the security client application.

9. The computer implemented method of claim 1, further comprising the step of encrypting a file containing sensitive information by the security client information on detecting transfer and storage activities performed by the user on said file containing said sensitive information.

10. The computer implemented method of claim 1, further comprising the step of terminating the local software component on termination of the security client application, wherein said step of termination comprises removing temporary files created by the local software component on the computing device of the user.

11. A computer implemented method of monitoring user activity and protecting information in an online environment, comprising the steps of:
providing a security client application on a computing device of a user;
embedding a local software component within said security client application, wherein said local software component is preloaded on said computing device;
authenticating said user by a policy server on receiving a request for access to said information from the user;
querying said policy server for a security policy for the user by the security client application for said access to the information;
permitting the user to perform predefined activities on the computing device of the user during the access of the information using the security client application based on said security policy, wherein said step of permitting the user to perform said predefined activities enables enforcement of the security policy; and
tracking said performed predefined activities of the user on the computing device using the security client application;
whereby said user activity is monitored and the information in said online environment is protected.

12. The computer implemented method of claim 11, wherein said step of permitting the user to perform the predefined activities on the computing device comprises preventing the user from performing activities apart from the predefined activities.

13. The computer implemented method of claim 11, further comprising the step of granting the user controlled access to the information using the embedded local software component via the security client application based on the security policy.

14. A computer implemented system for monitoring user activity and protecting information in an online environment, comprising:
a local software component embedded within a security client application on a computing device of a user;
a policy server for providing a security policy for said user;
said security client application provided on said computing device of a user, wherein the security client application comprises:
a query module for querying said policy server for said security policy on receiving a request for access to said information from the user;
an access control module for granting the user controlled access to the information based on the security policy, wherein said granted controlled access enables enforcement of the security policy, wherein said access control module allows the user the granted controlled access to the information using said embedded local software component;
an activity control module for permitting the user to perform predefined activities on the information using the granted controlled access; and
an activity tracking module for tracking said performed predefined activities on the information.

15. The computer implemented system of claim 14, wherein said activity control module prevents the user from performing activities apart from said predefined activities.

16. The computer implemented system of claim 14, wherein the security client application comprises a record transfer module for transferring a record of said tracked activities to the policy server for future use, wherein the policy server comprises a logging database for storing said record of the tracked activities.

17. The computer implemented system of claim 14, wherein said access control module disallows the user to access the information using the local software component independent of the security client application.

18. The computer implemented system of claim 14, wherein said activity tracking module tracks activities performed by the user on the computing device of the user.

19. The computer implemented system of claim 14, wherein the activity control module permits the user to perform predefined activities on the computing device of the user based on the security policy, wherein the activity control module prevents the user from performing activities apart from the predefined activities on the computing device.

20. The computer implemented system of claim 14, wherein the security client application comprises an alert generation module for generating an alert on detection of an attempt to violate the security policy.

21. The computer implemented system of claim 14, wherein the policy server comprises an authentication module for authenticating the user prior to receiving a query for the security policy from said query module.

22. The computer implemented system of claim 14, wherein the security client application further comprises a scanning and encryption module for scanning the information to detect sensitive information, wherein said scanning and encryption module encrypts a file containing sensitive information on detecting transfer and storage activities performed by the user on said file containing said sensitive information.

23. The computer implemented system of claim 14, wherein the security client application further comprises a termination module for terminating the local software component on termination of the security client application, wherein said termination module removes temporary files created by the local software component on the computing device.

24. The computer implemented system of claim 14, wherein the policy server comprises a policy database for storing the security policy of the user.

25. A computer program product comprising computer executable instructions embodied in a computer-readable medium, wherein said computer program product comprises:
a first computer parsable program code for providing a security client application on a computing device of a user;
a second computer parsable program code for embedding a local software component within said security client application, wherein said local software component is preloaded on said computing device;
a third computer parsable program code for querying a policy server for a security policy for said user by the security client application on receiving a request for access to information from the user;
a fourth computer parsable program code for granting the user controlled access to said information based on said security policy;
a fifth computer parsable program code for permitting the user to perform predefined activities on the information using said granted controlled access; and
a sixth computer parsable program code for tracking said performed predefined activities on the information using the security client application.
